(19) United States
(12) Patent Application Publication
(10) Pub. No.: US 2005/0048250 A1
(43) Pub. Date: Mar. 3, 2005

(54) Molding mold, substrate for optical disc, and optical disc

(75) Inventors: Kenji Yamaga, Tokyo (JP); Tsuyoshi Komaki, Tokyo (JP)

Correspondence Address: DARBY & DARBY P.C., P. O. BOX 5257, NEW YORK, NY, 10150-5257, US

(73) Assignee: TDK Corporation, Tokyo (JP)

(21) Appl. No.: 10/926,757

(22) Filed: Aug. 25, 2004

(30) Foreign Application Priority Data
Aug. 26, 2003 (JP) 2003-300799

(51) Int. Cl. B32B 3/02

(52) U.S. Cl. 428/64.4

(57) ABSTRACT

A molding mold assembly is provided, for molding a mold substrate for an optical disc, to reduce an occurrence of burrs, etc. adversely affecting the optical disc and to improve accuracy of thickness of the optical disc made by the mold substrate. A substrate for an optical disc is provided that is capable of improving the accuracy of the thickness, as well as an optical disc with the improved accuracy of the thickness. The molding mold assembly is constructed such that a cavity for molding the mold substrate for the optical disc is configured, a stamper for transferring a hyperfine pattern onto the mold substrate is attached to the mold assembly so that a vicinal part of an innermost periphery portion of the stamper protrudes towards the cavity, and a face formed by a mold member configuring an inner peripheral portion of the mold substrate is substantially flush with an information area face on which the hyperfine pattern has been transferred.

### INCORPORATION BY REFERENCE

The present application claims priority under 35 U.S.C. §119 to Japanese Patent Application No. 2003-300799 filed on Aug. 26, 2003. The content of the application is incorporated herein by reference in its entirety.

### BACKGROUND OF THE INVENTION

1. Field of the Invention

The present invention relates to a molding mold for molding an optical disc mold substrate for manufacturing an optical disc, the substrate for the optical disc, and the optical disc.

2. Description of the Prior Art

Conventional molding molds for molding an optical disc are constructed such that a stamper formed with hyperfine signal pits is held at its an inner peripheral portion within the molding molds, in which case an inner peripheral portion S1 of a stamper S is, as shown in FIG. 11A, pressed and thus held by use of a holder H including a collar portion H1 having a larger diameter than an inside diameter of the stamper. Further, as shown in FIG. 12A, the stamper S is held by vacuum suction from the inner peripheral portion of a backface of the stamper S by using a holder H′ having a guide portion H2 of which a diameter is substantially the same as the inside diameter of the stamper.

In a structure shown in FIG. 11A, however, the collar portion H1 of the holder protrudes into a cavity of the molds, and hence, as shown in FIG. 11B, a recessed portion A1 is formed in a mold substrate A. Especially when forming a variety of functional layers on this mold substrate by a spin coat method, this large recessed portion A1 (its depth is on the order of 0.2 mm to 0.3 mm) greatly hinders the spread of materials composing the functional layers, thereby inducing inconvenience such as unevenness of coating, coating streaks, or the like. Further, in a structure in FIG. 12A, the stamper S is fixed only by the vacuum suction, and therefore it follows that a mold resin enters a gap g between the stamper S and the guide portion H2 of the holder H′ when in a molding process, resulting in formation of a burr B1 on a mold substrate B as seen in FIG. 12B. The burr B1 also causes inconvenience to the formation of the functional layers that involves employing the same spin coat method as the above, and another inconvenience arises in the case of bonding a different substrate or the like onto the face formed with the burr.

For instance, in the case of forming, e.g., a light transmissive layer by the spin coat method in manufacturing the optical disc such as a Blu-ray disc (using blue laser beams) expected as a next generation high-density recording medium at the present, if there exists much of the recessed portion A1 (particularly as a stepped portion close to the outer periphery becomes larger and as an inclination of the wall get steeper) or the burr B1 on the mold substrate, as explained above, a problem also arises, wherein this causes a decline of spin coating property and occurrences of the coating streaks and the unevenness of the thickness.

Moreover, the mold substrate can be formed flat by eliminating the recessed portion in the mold substrate in a way that adjusts a level relationship between the stamper surface and a mold configuring the cavity within a central hole of the stamper, e.g., the surface of the holder. It is, however, impossible to restrain the occurrence of the burr by all means. This occurrence of the burr is conspicuous especially when the central hole of the stamper is punched out by a punch from the stamper surface. A protruded configuration can be provided in terms of the level relationship, however, in the case of manufacturing, e.g., a 2- or more-tiered disc spacer layer by use of a 2P method, there is a problem that the level (stepped portion) is required to be adjusted equal to or smaller than the thickness of this spacer layer, and the requirement of accuracy of the thickness becomes more strict.

For example, Japanese Patent Application Laid-Open Publication No.2003-11169 discloses that the stamper is fitted and thus held in a flat state at its inner peripheral portion by a stamper holding member. Even when set in the thus-fitted state, a burr might occur on the flat face.

### SUMMARY OF THE INVENTION

It is a primary object of the present invention to provide a molding mold, for molding a mold substrate for an optical disc, constructed to restrain an occurrence of a burr, etc. adversely affecting the optical disc and to enable an improvement of accuracy of thickness of the optical disc made by using the mold substrate.

It is another object of the present invention to provide a substrate for an optical disc that is constructed to enable the thickness accuracy to be improved.

It is a further object of the present invention to provide an optical disc with the improved thickness accuracy.

A molding mold according to an embodiment includes a mold member configuring a cavity for molding a mold substrate for an optical disc, and a stamper for transferring a hyperfine pattern onto the mold substrate, wherein the stamper is attached to the mold so that a vicinal part of an innermost periphery portion of the stamper protrudes on the side of the cavity, and a face formed by the mold member configuring an inner peripheral portion of the mold substrate is substantially flush with an information area face on which the hyperfine pattern has been transferred.

According to the present molding mold, the face formed by the mold member configuring the inner peripheral portion of the mold substrate is substantially flush with the information area face on which the hyperfine pattern of the stamper has been transferred, and the vicinal part of the innermost periphery portion of the stamper is disposed to protrude on the side of the cavity. Therefore, the burr produced between the stamper and the mold member becomes small enough not to be an obstacle against the spin coat on the mold substrate, and the resin is easy to flow toward the recessed portion corresponding to the vicinal part of the innermost periphery portion of the stamper. As a result, it is possible to restrain occurrences of coating streaks and unevenness of thickness, spin coating property is improved, and the thickness accuracy of the optical disc made by using the mold substrate can be improved.

Another molding mold according to the present embodiment includes a mold member configuring a cavity for molding a resin stamper applied to a photo polymer method (2P method) and used for transferring a hyperfine pattern onto a transferred face, and a stamper for transferring the hyperfine pattern onto the resin stamper, wherein the stamper is attached to the mold member so that a vicinal part of an innermost periphery portion of the stamper protrudes on the side of the cavity, and a face formed by the mold member configuring an inner peripheral portion of the resin stamper is substantially flush with an information area face on which the hyperfine pattern has been transferred.

According to the present molding mold, the face formed by the mold member configuring the inner peripheral portion of the resin stamper used in the 2P method is substantially flush with the information area face on which the hyperfine pattern of the stamper has been transferred, and the vicinal part of the innermost periphery portion of the stamper is disposed to protrude on the side of the cavity. Therefore, the burr produced between the stamper and the mold member becomes small enough not to be the obstacle against the spin coat on the mold substrate, and the resin is easy to flow toward the resin tamper recessed portion corresponding to the vicinal part of the innermost periphery portion of the stamper. As a result, it is possible to restrain the occurrences of the coating streaks and the unevenness of thickness, the spin coating property is improved, and the thickness accuracy of the optical disc made by using the mold substrate can be improved.

In each the molding mold described above, it is preferable that the vicinal part of the inner periphery portion of the stamper, which protrudes on the side of the cavity, is positioned within a range of 0.3 mm through 5 mm on the side of an outer periphery in a radial direction from the innermost periphery of the stamper.

Note that preferably, the stamper has a central hole formed in its inner peripheral portion and is disposed so that the central hole gets fitted to the mold member.

A disc-shaped substrate for an optical disc according to the present embodiment includes an inner peripheral face so formed as to be configured by a mold member, and an information area face containing an information recording area in which a hyperfine pattern is transferred on the side of an outer periphery of the inner peripheral surface, wherein the inner peripheral face is substantially flush with the information area face, and a recessed portion formed by the vicinal part of the inner peripheral portion of the stamper is configured between the inner peripheral face and the information area face.

According to this substrate for the optical disc, the inner peripheral face is substantially flush with the information area face, and the recessed portion is formed between the inner peripheral face and the information area face. Therefore, the resin is easy to flow in the spin coating. As a result, it is possible to restrain the occurrences of the coating streaks and the unevenness of thickness, the spin coating property is improved, and the thickness accuracy of the optical disc made by using the substrate for the optical disc can be improved.

In the disc-shaped substrate for the optical disc, it is preferable that the recessed portion configured between the information area face and the inner peripheral face is formed so that an inclined face extending towards the information area face has a more gentle slope than an inclined face extending towards the inner peripheral face from a deepest part of the recessed portion.

It is also preferable that the recessed portion is positioned within a range of 0.3 mm through 5 mm on the outer peripheral side in the radial direction from a position where the recess starts from the inner peripheral face.

An optical disc according to the present invention includes a substrate for an optical disc, including an inner peripheral face so formed as to be configured by a mold member, and an information area face having an information recording area in which a hyperfine pattern is formed on the side of an outer periphery of the inner peripheral surface, the inner peripheral face being substantially flush with the information area face, and a recessed portion formed by the vicinal part of the inner peripheral portion of the stamper being configured between the inner peripheral face and the information area face, and a resin layer formed on the substrate for the optical disc.

According to the present optical disc, in the substrate for the optical disc, the inner peripheral face is substantially flush with the information area face, and the recessed portion is formed between the inner peripheral face and the information area face. Therefore, the resin is easy to flow in the spin coating. As a result, it is possible to restrain the occurrences of the coating streaks and the unevenness of thickness, the spin coating property is improved, and the thickness accuracy of the substrate for the optical disc and of the optical disc can be improved.

In the optical disc described above, the resin layer can be a light transmissive layer. With this contrivance, the optical disc having a 1-tiered information layer can be built up.

Further, it is preferable that the substrate for the optical disc is formed with the recessed portion configured between the information area face and the inner peripheral face so that an inclined face extending towards the information area face has a more gentle slope than an inclined face extending towards the inner peripheral face from a deepest part of the recessed portion.

It is also preferable that the recessed portion is positioned within a range of 0.3 mm through 5 mm on the outer peripheral side in the radial direction from a position where the recess starts from the inner peripheral face.

Another optical disc according to the present embodiment includes at least a substrate for an optical disc, including an inner peripheral face so formed as to be configured by a mold member, and an information area face having an information area in which a hyperfine pattern is formed on the side of an outer periphery of the inner peripheral surface, the inner peripheral face being substantially flush with the information area face, and a recessed portion formed by the vicinal part of the inner peripheral portion of the stamper being configured between the inner peripheral face and the information area face, and a resin layer formed on the substrate for the optical disc and formed with a hyperfine pattern on its surface.

According to the present optical disc, in the substrate for the optical disc, the inner peripheral face is substantially flush with the information area face, and the recessed portion is formed between the inner peripheral face and the information area face. Therefore, the resin is easy to flow in the spin coating based on the 2P method. As a result, it is possible to restrain the occurrences of the coating streaks and the unevenness of thickness, the spin coating property is improved, and therefore the thickness accuracy of the substrate for the optical disc and of the optical disc can be improved. In this optical disc, the resin layer is formed as a spacer layer.

In the optical disc, it is preferable that the substrate for the optical disc is formed with the recessed portion configured between the information area face and the inner peripheral face so that an inclined face extending towards the information area face has a more gentle slope than an inclined face extending towards the inner peripheral face from a deepest part of the recessed portion.

Moreover, it is preferable that the recessed portion is positioned within a range of 0.3 mm through 5 mm on the outer peripheral side in the radial direction from a position where the recess starts from the inner peripheral face.

Further, the optical disc further includes a light transmissive layer formed on the surface of the resin layer, whereby the optical disc having the multi-tiered information layer can be built up.

Still another optical disc according to the present embodiment includes at least a substrate for the optical disc, and a resin layer formed on the substrate for the optical disc, wherein a face, opposite to the substrate, of the resin layer is formed corresponding to a resin stamper including an inner peripheral face so formed as to be configured by a mold member and an information area face having an information area in which a hyperfine pattern is formed on the side of an outer periphery of the inner peripheral surface, the inner peripheral face is substantially flush with the information area face, and a protruded portion is formed between the inner peripheral face and the information area face.

According to the present optical disc, in the formation of the resin layer, the inner peripheral face is substantially flush with the information area face, and the recessed portion is formed between the inner peripheral face and the information area face of the resin stamper. Therefore, the resin is easy to flow in the spin coating. As a result, it is possible to restrain the occurrences of the coating streaks and the unevenness of thickness, the spin coating property is improved, and therefore the thickness accuracy of the resin layer and of the optical disc can be improved.

In the optical disc described above, it is preferable that the resin layer is formed with the protruded portion between the information area face and the inner peripheral face so that an inclined face extending towards the information area face has a more gentle slope than an inclined face extending towards the inner peripheral face from a highest part of the protruded portion.

It is further preferable that the protruded portion is positioned within a range of 0.3 mm through 5 mm on the outer peripheral side in the radial direction from a position where the protrusion starts from the inner peripheral face.

Moreover, at least a plurality of resin layers are provided, whereby the optical disc having the multi-tiered information layer can be built up.

Still moreover, the optical disc may further include a light transmissive layer formed at least on the surface of the resin layer.

Yet another optical disc according to the present embodiment includes at least a substrate for the optical disc including an inner peripheral face so formed as to be configured by a mold member, and an information area face having an information area in which a hyperfine pattern is formed on the side of an outer periphery of the inner peripheral surface, the inner peripheral face being substantially flush with the information area face, and a recessed portion formed by the vicinal part of the inner peripheral portion of the stamper being configured between the inner peripheral face and the information area face, and a resin layer formed on the substrate for the optical disc, wherein a face, opposite to the substrate, of the resin layer is formed corresponding to a resin stamper including an inner peripheral face so formed as to be configured by a mold member and an information area face having an information area in which a hyperfine pattern is formed on the side of an outer periphery of the inner peripheral surface, the inner peripheral face is substantially flush with the information area face, and a protruded portion is formed between the inner peripheral face and the information area face.

According to the present optical disc, in the substrate for the optical disc, the inner peripheral face is substantially flush with the information area face, and the recessed portion is formed between the inner peripheral face and the information area face. Therefore, the resin is easy to flow in the spin coating. As a result, it is possible to restrain the occurrences of the coating streaks and the unevenness of thickness, the spin coating property is improved, the inner peripheral face and the information area face in the resin layer are substantially flush with each other, and the recessed portion is formed between the inner peripheral face and the information area face. Therefore, the resin is easy to flow in the spin coating. Consequently, it is feasible to restrain the occurrences of the coating streaks and the unevenness of thickness, the spin coating property is improved, and hence the thickness accuracy of the resin layer and of the optical disc can be improved.

In the optical disc described above, it is preferable that the substrate for the optical disc is formed with the recessed portion configured between the information area face and the inner peripheral face so that an inclined face extending towards the information area face has a more gentle slope than an inclined face extending towards the inner peripheral face from a deepest part of the recessed portion. In this case, it is preferable that the recessed portion is positioned within a range of 0.3 mm through 5 mm on the outer peripheral side in the radial direction from a position where the recess starts from the inner peripheral face.

Further, it is preferable that the resin layer is formed with the protruded portion between the information area face and the inner peripheral face so that an inclined face extending towards the information area face has a more gentle slope than an inclined face extending towards the inner peripheral face from a highest part of the protruded portion. In this case, it is preferable that the protruded portion is positioned within a range of 0.3 mm through 5 mm on the outer peripheral side in the radial direction from a position where the protrusion starts from the inner peripheral face.

Yet further, at least a plurality of resin layers can be provided, and the optical disc may further include a light transmissive layer formed at least on the surface of the resin layer. According to the present embodiment, it is possible to provide the molding mold, for molding the mold substrate for the optical disc, constructed to restrain the occurrence of the burr, etc. adversely affecting the optical disc and to enable the improvement of the accuracy of thickness of the optical disc made by using the mold substrate.

Moreover, it is feasible to provide the substrate for the optical disc that is constructed to enable the thickness accuracy to be improved. Still moreover, the optical disc with the improved thickness accuracy can be provided.

### BRIEF DESCRIPTION OF THE DRAWINGS

FIG. 1 is a sectional view of a principal portion of a molding mold assembly according to the present embodiment;

FIG. 2A is an enlarged principal sectional view showing a one-sided principal portion in the vicinity of a center of a fixed mold 21 in FIG. 1; FIG. 2B is a principal sectional view of the mold substrate molded by the present molding mold assembly; FIG. 2C is an enlarged view C of the surface of this mold substrate;

FIG. 3A is an enlarged principal sectional view showing how a burr occurs when molding the mold substrate by use of the molding mold assembly shown in FIGS. 1 and 2A; FIG. 3B is an enlarged principal sectional view showing how the burr occurs when molding the mold substrate by use of the conventional molding mold assembly;

FIGS. 4A to 4C are sectional views showing a one-sided half portion of the mold substrate, etc., and illustrating a process of manufacturing the optical disc from the mold substrate in FIG. 2B that has been molded by the molding mold assembly shown in FIGS. 1 and 2A;

FIG. 5A shows an example of the molding mold assemble having a different construction from that in FIG. 2A, and is an enlarged principal sectional view showing a one-sided principal portion of the fixed mold in the vicinity of the center in FIG. 1; FIG. 5B is a principal sectional view of the mold substrate molded by this molding mold assembly; FIG. 5C is an enlarged view of the surface of this mold substrate;

FIGS. 6A to 6G are sectional views of the mold substrate, etc., and illustrate the process of manufacturing the optical disc from the mold substrate in FIG. 5B that has been molded by the molding mold assembly shown in FIGS. 1 and 5A;

FIG. 7 is an enlarged principal sectional view showing how a spacer layer is formed through the spin coating process in FIG. 6D;

FIG. 8A is an enlarged principal sectional view showing how the spacer layer is formed on the mold substrate molded by a conventional molding mold assembly; FIG. 8B is an enlarged principal sectional view showing how the spacer layer is formed on the mold substrate molded by another conventional molding mold assembly;

FIG. 9A shows a modified example of the molding mold assembly in FIG. 5A, and is an enlarged principal sectional view showing a one-sided principal portion of the fixed mold in the vicinity of the center in FIG. 1; FIG. 9B is a principal sectional view of the mold substrate molded by this molding mold assembly; FIG. 9C is an enlarged view of the surface of this mold substrate;

FIG. 10A shows another modified example of the molding mold assembly in FIG. 5A, and is an enlarged principal sectional view showing a one-sided principal portion of the fixed mold in the vicinity of the center in FIG. 1; FIG. 10B is a principal sectional view of the mold substrate molded by this molding mold assembly; FIG. 10C is an enlarged view of the surface of this mold substrate;

FIG. 11A is a principal sectional view of a conventional molding mold assembly; FIG. 11B is a principal sectional view of the mold substrate thereof;

FIG. 12A is a principal sectional view of another conventional molding mold assembly; FIG. 12B is a principal sectional view of the mold substrate thereof; and

FIG. 13 is a sectional view showing a one-sided half portion of a sectional construction of a 2-tiered optical disc that can be manufactured in the process shown in FIGS. 6A to 6G.

### DETAILED DESCRIPTION OF THE PREFERRED EMBODIMENTS

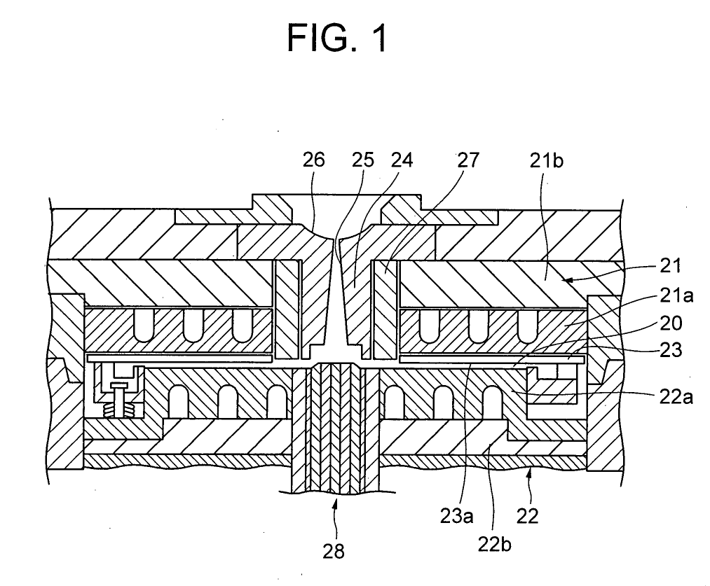

A best mode for carrying out the present invention will hereinafter be described with reference to the drawings. FIG. 1 is a sectional view of a principal portion of a molding mold assembly according to the present embodiment. This molding mold assembly serves to mold a plastic mold substrate for optical discs such as a CD, a DVD, a Blu-ray disc and so on.

The molding mold assembly shown in FIG. 1 includes a fixed mold 21 and a movable mold 22. The fixed mold 21 has a fixed mirror surface portion 21a, a fixed mold plate 21b, a holder member 27 disposed in the vicinity of the center, and a sprue bush 24 disposed at the center on the side of an inside diameter of the holder member 27. Further, the movable mold 22 has a movable mirror surface portion 22a, a movable mold plate 22b and an ejection member 28 driven upwards as viewed in FIG. 1 in order to extract a mold product when in mold releasing after being molded.

A stamper 23 is composed of nickel, etc., in a plate-like shape. The stamper 23 has a stamper face 23a on the side of a cavity 20, which is formed with a hyperfine rugged pattern for recording, for instance, pieces of information. The stamper 23 is disposed in close proximity to the fixed mirror surface portion 21a of the fixed mold 21.

The cavity 20 having a configuration corresponding to a configuration of the mold substrate defined as a molded product, is formed between the stamper 23 of the fixed mold 21 and the movable mirror surface portion 22a of the movable mold 22. An end face 27a of the holder member 27 configures part of the cavity 20.

According to the molding mold assembly in FIG. 1, a melted resin material is injected via an injecting portion 25 of the sprue bush 24 into the cavity 20 from an injection nozzle (unillustrated) abutting on an abutment face 26 of the sprue bush 24 of the fixed mold 21, whereby the mold substrate can be injection-molded.

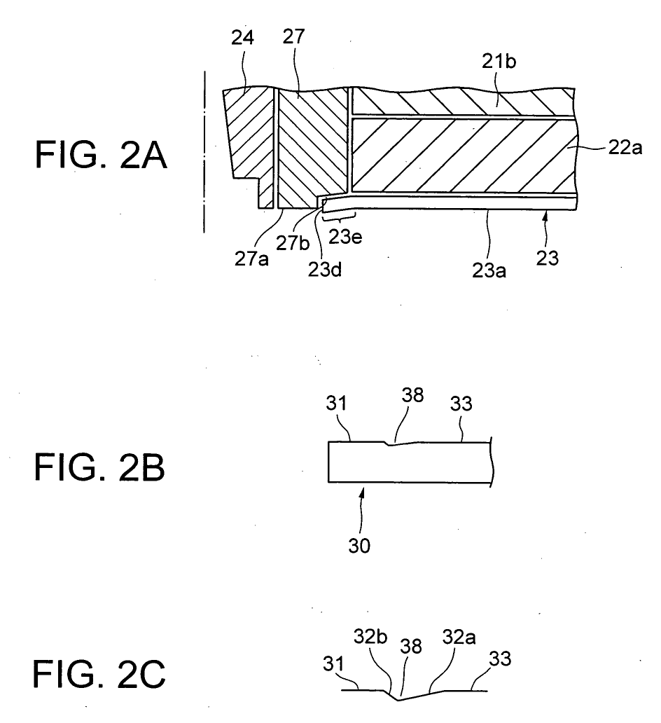

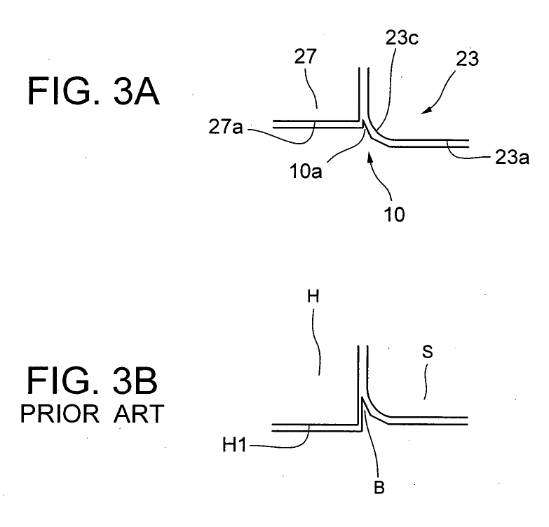

Next, a fitting position of the stamper in the fixed mold 21 of the molding mold assembly in FIG. 1 will be explained with reference to FIGS. 2A to 2C, 3A and 3B.

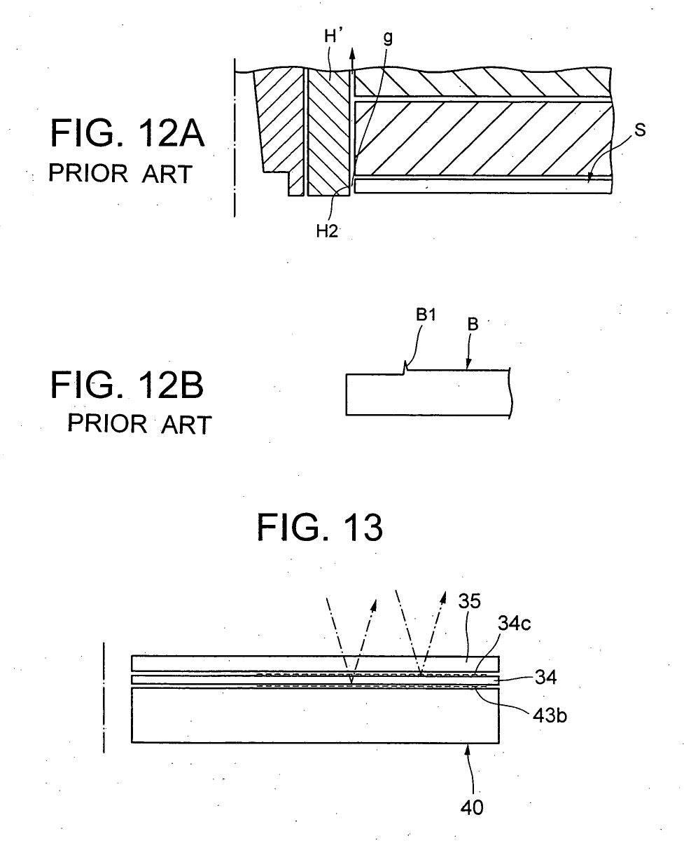

FIG. 2A is an enlarged principal sectional view showing a one-sided principal portion in the vicinity of the center of the fixed mold 21 in FIG. 1. FIG. 2B is a principal sectional view of the mold substrate molded by the present molding mold assembly. FIG. 2C is an enlarged view C of the surface of this mold substrate. FIG. 3A is an enlarged principal sectional view showing how a burr occurs when molding the mold substrate by use of the molding mold assembly shown in FIGS. 1 and 2A. FIG. 3B is an enlarged principal sectional view showing how the burr occurs when molding the mold substrate by use of the conventional molding mold assembly (FIG. 12A).

As shown in FIG. 2A, the stamper 23 is held such that a central hole 23d of an inner peripheral portion of the stamper 23 gets fitted to the holder member 27. The stamper 23 is disposed so that an inner peripheral portion of the stamper face 23a protrudes towards the cavity 20 from the end face 27a of the holder member 27.

Further, a bottom face of a recessed portion 27b in the end face 27a of the holder member 27 in FIG. 1 is tapered as shown in FIG. 2A. An innermost periphery vicinal portion 23e of the stamper 23, which is positioned in the recessed portion 27b, is formed as a tapered face inclined low from the stamper face 23. Herein, the innermost periphery vicinal portion 23e represents a doughnut-shaped area extending over a range of 0.3 mm through 5 mm in a radial direction from an edge of the central hole 23d.

As shown in FIG. 2A, the innermost periphery vicinal portion 23e of the stamper 23 is formed as a curvature face or an inclined face (tapered face) so that the innermost periphery vicinal portion 23e is positioned at the tapered face of the recessed portion 27b of the holder member 27 and is thus slightly inclined along this tapered face, and its edge (the edge of the central hole 23d) protrudes towards the cavity 20 from the end face 27a of the holder member 27. The stamper face 23a apart from the innermost periphery vicinal portion 23e is a flat face that is substantially flush with (the same level as) the end face 27a of the holder member 27 (with respect to their positions in the vertical direction in FIG. 2A). The stamper 23 is disposed in such a way that the central hole 23d gets fitted via the recessed portion 27b to the holder member 27.

A mold substrate 30 molded by the molding mold assembly in FIG. 2A is, as shown in FIG. 2B, formed with a recessed portion 38 recessed corresponding to the innermost periphery vicinal portion 23e between an inner peripheral face 31 and an information area face 33. The recessed portion 38 is configured corresponding to the innermost periphery vicinal portion 23e and is therefore formed with, as shown in FIG. 2C, an inner periphery sided wall face 32b and an inclined state 32a as an intermediate configuration between the bottom face and an outer periphery sided wall face.

Further, a burr produced on the inner periphery sided wall face 32b of the recessed portion 38 corresponding to a portion between the holder member 27 and the stamper 23 is comparatively small as seen in FIG. 3A, wherein a height of the burr can be set less than, e.g., 20 μm. Note that an amount of the recess down to the deepest part of the recessed portion 38 from the information area face 33 or the inner peripheral face 31 be, it is preferable, within a range of 5 μm through 50 μm.

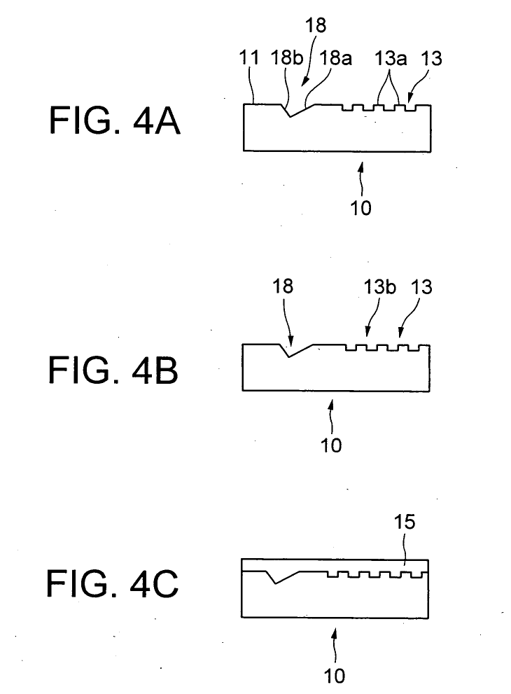

A process of manufacturing a Blu-ray disc from the thus-acquired mold substrate molded as described above, will be explained with reference to FIGS. 4A to 4C. FIGS. 4A to 4C are sectional views showing a one-sided half portion of the mold substrate, and illustrating the process of manufacturing the optical disc from the mold substrate in FIG. 2B that has been molded by the molding mold assembly shown in FIGS. 1 and 2A.

To start with, a mold substrate 10, which is, e.g., 120 mm in diameter and 1.1 mm in thickness, is molded of a polycarbonate (PC) resin by use of the molding mold assembly in FIGS. 1 and 2A. The mold substrate 10 is thereby formed with, as shown in FIG. 4A, an inner peripheral face 11, a recessed portion 18 and an information area face 13. The information area face 13 is formed with a hyperfine rugged portion 13a containing grooves, pits, etc. that are transferred from the stamper 23.

Next, layer formation (e.g., sputtering) of a variety of functional layers such as a recording layer, a reflection layer, etc. is effected on the information area face 13 of the mold substrate 10. As shown in FIG. 4B, for example, in the case of a playback-only optical disc, a reflection layer 13b composed of aluminum, etc. is formed by sputtering on the hyperfine rugged portion 13a containing the groves, the pits, etc. It should be noted that in the case of a recordable type optical disc such as a write-once optical disc, a rewritable optical disc and so on, the functional layers such as the recording layer, etc., are formed on the hyperfine rugged portion 13a containing the grooves, the pits, etc. in accordance with a variety of purposes.

Next, a resin (e.g., an ultraviolet curing acrylic resin) layer is coated over the mold substrate 10 formed with the variety of functional layers. This resin layer is coated as a protective layer performing a role of physically or chemically protecting the variety of functional layers in the case of the optical disc such as a CD and a DVD classified as a type of being irradiated with laser beams used for recording and reproducing through the substrate.

Moreover, in the case of a high-NA type optical disc as represented by the Blu-ray disc, the disc is irradiated with the laser beams sued for recording and reproducing from the side opposite to the substrate and is therefore formed with a light transmissive layer over the variety of functional layers. A method of forming the light transmissive layer can involve, though not particularly limited, a case of forming by a spin coat method and a case of bonding and thus providing a separately prepared seat composed of a resin (which is a polycarbonate resin, an acrylic resin, etc.).

The spin coat method is that the resin is coated over the mold substrate 10 formed with the variety of functional layers in a way that rotates the mold substrate 10 at a comparatively low speed, and a resin layer having target layer thickness is to be formed by controlling the number of rotations and a period of rotation time.

In the case of the ultraviolet curing acrylic resin, irradiation of ultraviolet rays is next effected, whereby a resin layer (a light transmissive layer 15) that is 0.1 mm in thickness is, as shown in FIG. 4C, formed over the entire surface of the mold substrate 10 including the information area face 13.

It is possible to manufacture in the way described above a Blu-ray disc using blue laser beams of which a wavelength is, e.g., 405 nm as the recording/producing laser beams and capable of recording and reproducing through an optical system to which an optical pickup constructed of an objective lens group having a numerical aperture (NA) of 0.85 (NA=0.85) is applied.

In the aforementioned manufacturing process, on the surface of the mold substrate 10, there is no protrusion (a protruded portion in terms of a mold structure) hindering a flow of the resin towards the outer peripheral portion from the inner peripheral face 11 supplied with the resin, and besides the burr formed in the vicinity of the inner periphery sided wall face 18b of the recessed portion 18 is small and does not therefore become an obstacle against the spin coat. Thus, the surface of the mold substrate 10 exhibits a preferable spin coating property, and hence it is feasible to restrain occurrences of coating streaks and unevenness in thickness and to improve accuracy of the thickness of the light transmissive layer 15. This enables an improvement of accuracy of the thickness of the optical disc.

Furthermore, in the case of the optical disc such as the Blu-ray disc, etc., the inner peripheral surface 11 might become a fiducial face (clamp face) when the optical disc is installed into a recording/reproducing apparatus, and is employed as a reference for performing the record and reproduction on and form the information area face 33. Therefore, this positional relationship, if determined based on specifications, can not be changed voluntarily. The height positional relationship that the heights of these two faces are substantially equal to each other, is extremely vital and effective in recording/reproducing process.

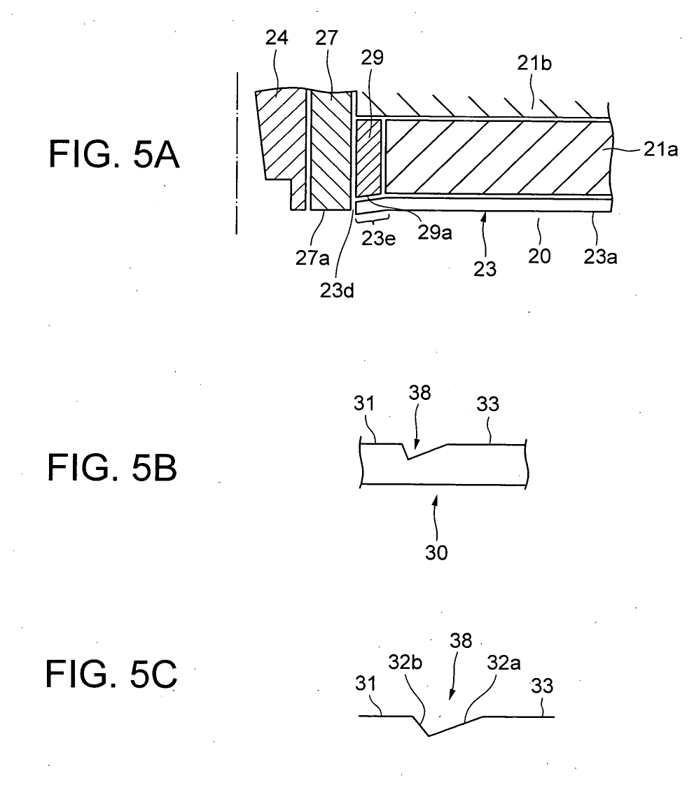

The whole structure of the molding mold assembly is the same as in FIG. 1, however, another example that the innermost periphery vicinal portion of the stamper is protruded towards the cavity, will next be explained with reference to FIGS. 5A to 5C. FIG. 5A shows an example of the molding mold assemble having a different construction from that in FIG. 2A, and is an enlarged principal sectional view showing a one-sided principal portion of the fixed mold in the vicinity of the center in FIG. 1. FIG. 5B is a principal sectional view of the mold substrate molded by this molding mold assembly. FIG. 5C is an enlarged view of the surface of this mold substrate.

As illustrated in FIG. 5A, in the fixed mold 21 of the molding mold assembly in FIG. 1, a sleeve member 29 is disposed between the inner periphery sided lateral face of the fixed mirror surface portion 21a and an outer periphery sided lateral face of the holder member 27. In the fixed mold 21, an end face 29a of the sleeve member 29 is positioned (corresponding to the recessed portion 27b in FIG. 2A) at the innermost periphery vicinal portion 23e on the side of a backface of the stamper 23, and the innermost periphery vicinal portion 23e of the stamper 23 is formed as a tapered face inclined low from the stamper face 23a. Then, the sleeve member 29 is disposed so that the end face 29a pushes the innermost periphery vicinal portion 23e from its backface.

The innermost periphery vicinal portion 23e of the stamper 23 is pushed by the end face 29a of the sleeve member 29 and is thereby slightly inclined, and its edge (the edge of the central hole 23d) protrudes from the end face 27a of the holder member 27 towards the cavity 20, thus forming a tapered face inclined therefrom. The stamper face 23a apart from the innermost periphery vicinal portion 23e is a flat face that is substantially flush with (the same level as) the end face 27a of the holder member 27.

Note that an amount of the protrusion of the innermost periphery vicinal portion 23e can be adjusted by changing a height position of the sleeve member 29.

The mold substrate 30 molded by the molding mold assembly shown in FIGS. 1 and 5A is, as shown in FIG. 5B, formed with the inner peripheral face 31 corresponding to the end face 27a of the holder member 27 and further formed with the information area face 33 onto which the hyperfine rugged pattern is transferred from the stamper face 23a, wherein the information area face 33 is substantially flush with the inner peripheral face 31. The recessed portion 38 recessed corresponding to the innermost periphery vicinal portion 23e is formed between the inner peripheral face 31 and the information area face 33. The recessed portion 38 is configured corresponding to the innermost periphery vicinal portion 23e and is therefore formed with, as shown in FIG. 2C, the inner periphery sided wall face 32b and the inclined state 32a as the intermediate configuration between the bottom face and the outer periphery sided wall face.

Further, the burr produced on the inner periphery sided wall face 32b of the recessed portion 38 corresponding to the portion between the holder member 27 and the stamper 23 is comparatively small as seen in FIG. 3A, wherein the height of the burr can be set less than, e.g., 20 μm. Note that the amount of the recess down to the bottom face of the recessed portion 38 from the information area face 33 or the inner peripheral face 31 be, it is preferable, within the range of 5 μm through 50 μm.

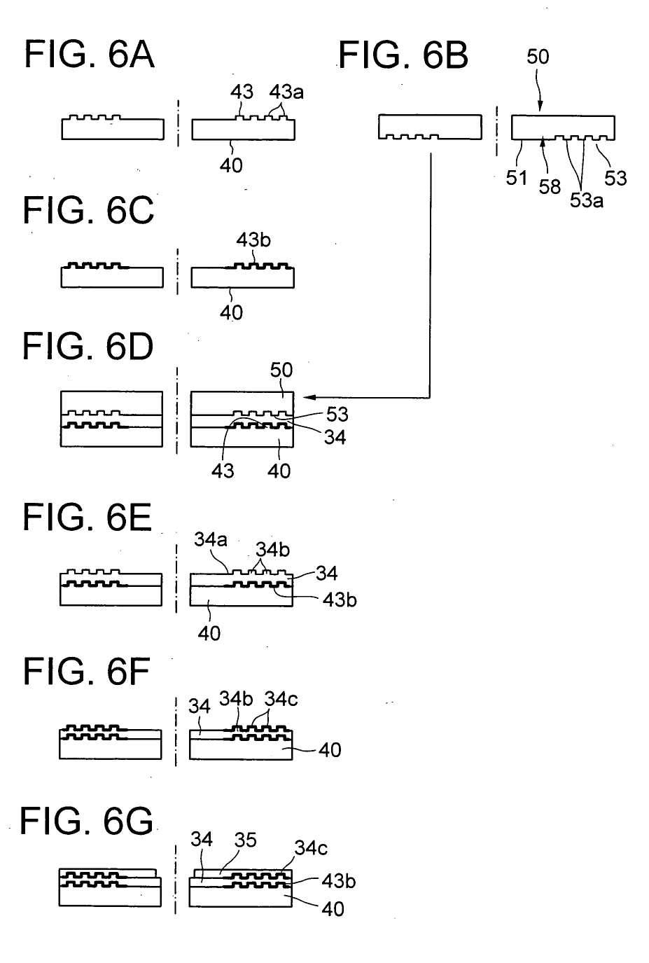

Next, a process of manufacturing a Blu-ray disc having a 2-tiered information layer from the thus-acquired mold substrate molded as described above, will be described with reference to FIGS. 6A to 6G. FIGS. 6A to 6G are sectional views of the mold substrate, etc., and illustrate the process of manufacturing the optical disc from the mold substrate in FIG. 5B that has been molded by the molding mold assembly shown in FIGS. 1 and 5A.

To begin with, as shown in FIG. 6A, a mold substrate 40, which is, e.g., 120 mm in diameter and 1.1 mm in thickness, is molded of the polycarbonate (PC) resin. The mold substrate 40 is formed with an information area face 43 by use of the stamper.

Next, the layer formation (e.g., sputtering) of the variety of functional layers such as the recording layer, the reflection layer, etc. is effected on the information area face 43 of the mold substrate 40. For instance, in the case of the playback-only optical disc, a reflection layer composed of aluminum, etc. is formed by sputtering on the hyperfine rugged portion 43a containing the groves, the pits, etc. It should be noted that in the case of the recordable type optical disc such as the write-once optical disc, the rewritable optical disc and so on, the functional layers such as the recording layer, etc., are formed on the hyperfine rugged portion 43a containing the grooves, the pits, etc. in accordance with a variety of purposes.

On the other hand, an olefin resin mold substrate 50, which is, e.g., 120 mm in diameter, is molded of an olefin resin by use of the same molding mold assembly as in FIGS. 1, 2A and 5A. As shown in FIG. 6B, the olefin resin mold substrate 50 is formed with an inside diameter portion 51, a recessed portion 58 and an information area face 53 as shown in FIGS. 2B, 2C, 5B and 5C, and the information area face 53 is formed with a hyperfine rugged portion 53a containing the grooves, the pits, etc., transferred from the stamper.

Next, a resin is coated over the olefin resin mold substrate 50 in a way that rotates this substrate 50 at a comparatively low speed, and a resin layer having target layer thickness is to be formed by controlling the number of rotations and a period of rotation time. Subsequently, each mold substrate is disposed so that the information area face 43 of the PC resin mold substrate 40 faces the information area face 54 of the olefin resin mold substrate, and is thus made tightly contiguous to the PC resin mold substrate 40. When the coated resin is of the ultraviolet curing type, the resin is cured by the irradiation of the ultraviolet rays, thereby forming a spacer layer 34 having thickness of 25 μm as shown in FIG. 6D.

Next, as shown in FIG. 6E, the spacer layer 34 and the olefin resin mold substrate 50 are exfoliated from each other, and the olefin resin mold substrate 50 is removed away in a state where the spacer layer 34 is formed sticking to the mold substrate 40. This exfoliation is comparatively easy to perform if designed to have a strong bonding force between the resin composing the spacer layer 34 and the PC resin mold substrate and to have weak bonding force adhesion between the resin composing the spacer layer 34 and the olefin resin mold substrate 50. The olefin resin mold substrate 50 is removed away in this process, whereby an external face 34a of the spacer layer 34 is formed with a hyperfine rugged portion 34b containing grooves, pits, etc. corresponding to the hyperfine rugged portion 53a containing the grooves, the pits, etc. that are previously formed on the olefin resin mold substrate 50.

Next, the layer formation (e.g., sputtering) of the variety of functional layers such as the recording layer, the reflection layer, etc., which can transmit a required amount of laser beams applied to the record and the reproduction, is again effected on the outer face 34a of the spacer layer 34 on the mold substrate 40. As shown in FIG. 6F, for instance, in the case of the playback-only optical disc, a reflection layer 34c composed of aluminum, etc. is formed by sputtering, etc. on the hyperfine rugged portion 34b containing the groves, the pits and so on. Note that in the case of the recordable type optical disc such as the write-once optical disc, the rewritable optical disc and so on, the functional layers such as the recording layer, etc., are formed on the hyperfine rugged portion 34b in accordance with a variety of purposes.

Subsequently, a resin (e.g., an ultraviolet curing acrylic resin) layer (light transmissive layer) is formed on the mold substrate 40 provided with the variety of functional layers.

The method of forming the light transmissive layer can involve, though not particularly limited, the case of forming by the spin coat method and the case of bonding and thus providing the separately prepared seat composed of the resin (which is the polycarbonate resin, the acrylic resin, etc.).

The spin coat method is that the resin is coated over the mold substrate 40 formed with the variety of functional layers in a way that rotates the mold substrate 40 at a comparatively low speed, and the resin layer having target layer thickness is to be formed by controlling the number of rotations and a period of rotation time.

In the case of the ultraviolet curing acrylic resin, the resin is next cured by effecting the irradiation of ultraviolet rays, whereby the light transmissive layer 35 that is 75 μm in thickness is, as shown in FIG. 6G, formed on the surface formed with the variety of functional layers.

The Blu-ray disc having the 2-tiered information layer as shown in FIG. 13 can be manufactured in the way described above. The Blu-ray disc having the 2-tiered information layer involves using the blue laser beams of which a wavelength is, e.g., 405 nm as the laser beams for recording and reproducing, and is capable of recording and reproducing through the optical system to which the optical pickup constructed of the objective lens group having the numerical aperture (NA) of 0.85 (NA=0.85) is applied. The blue laser beams traveling from the light transmissive layer (cover layer) 35 in FIG. 13 are converged at a deep side layer 43b as indicated by a one-dotted chain line in FIG. 13, thereby performing the record and the reproduction. Further, the blue laser beams are converged at a shallow side layer 34c as indicated by a broken line, thereby performing the record and the reproduction.

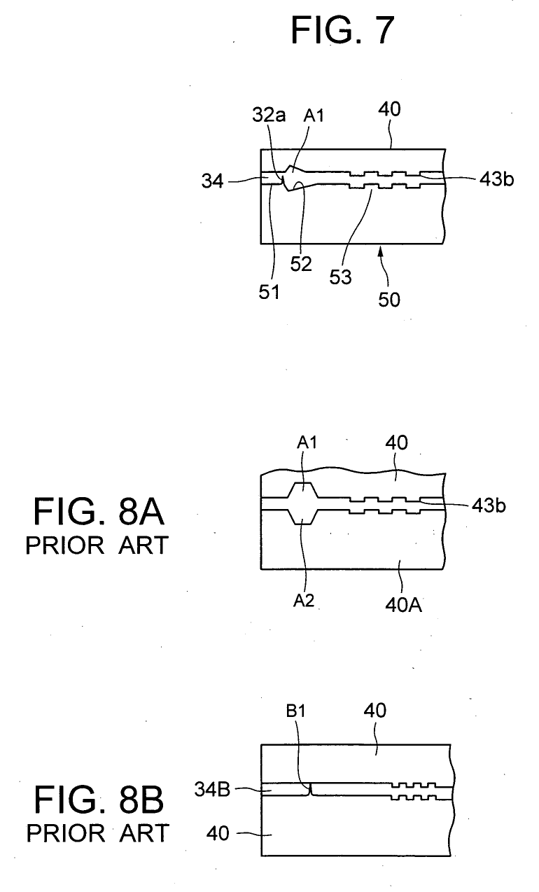

Effects in the aforementioned process of manufacturing the optical disk in FIG. 6D will be explained with reference to FIG. 7. FIG. 7 is an enlarged principal sectional view showing how the spacer layer is formed through the coating process based on the spin coat method in FIG. 6D.

When the spacer layer 34 is formed on the olefin resin mold substrate 50 by the spin coat method, there is no protrusion (the protruded portion in terms of the mold structure) hindering the flow of the resin towards the outer peripheral portion from the inside diameter portion 51 supplied with the resin, and consequently the coating is preferably conducted. Besides, as shown in FIG. 5C, in the recessed portion (38), the outer periphery sided wall face 32a extending towards the outer periphery from the wall face of the inner peripheral face has a more moderate inclination than the inner periphery sided wall face 32b, wherein the resin is easy to spread. Further, as shown in FIG. 7, a burr 52a formed in the vicinity of the recessed portion 52 is comparatively small and does not therefore become an obstacle against the spin coat. Thus, the surface of the olefin resin mold substrate 50 exhibits a preferable spin coating property, and hence it is feasible to restrain occurrences of coating streaks and unevenness in thickness and to improve accuracy of the thickness of the spacer layer 34. This enables an improvement of accuracy of the thickness of the optical disc as the whole.

Moreover, as shown in FIG. 7, the aforementioned spacer layer 34 is formed to the thickness of 25 μm on the face formed with the burr 52a of the olefin resin mold substrate 50, however, a height of the burr 52a is comparatively as small as less than 20 μm and is still smaller than the thickness of the spacer layer 34. Accordingly, a contrivance that the spacer layer 34 is formed to the thickness of 25 μm eliminates an influence of the burr 32a. It is therefore possible to uniformly accurately form the spacer layer 34 and to improve the accuracy of the thickness of the whole optical disk.

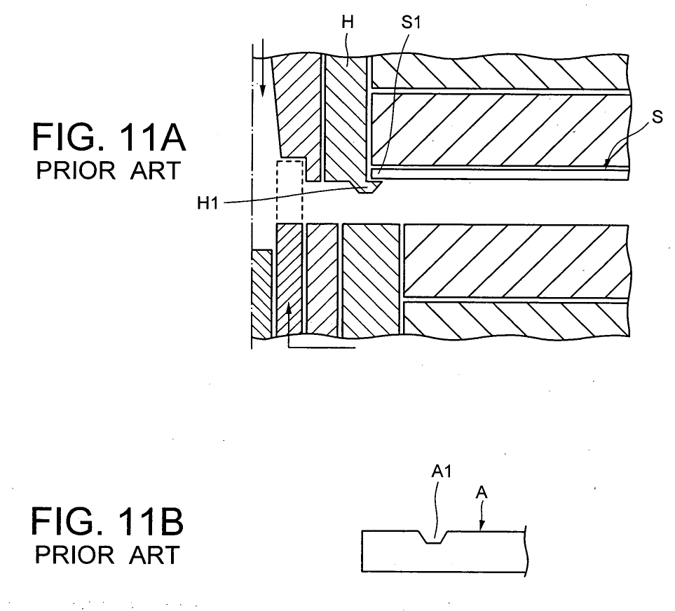

By contrast, as shown in FIG. 8A, on an olefin resin mold substrate 40A molded by the conventional molding mold assembly as shown in FIG. 11A, since a comparatively large recessed portion A2 exists between an inside diameter portion and an information area face, the spin coating property is poor, and the coating property of a spacer layer 34A declines, with the result that defects such as the coating streaks occur. Further, after exfoliating and removing the olefin resin mold substrate 40A, as a protruded portion corresponding to the recessed portion A2 is formed on the surface of the spacer layer 34A, the spin coating property when forming the light transmissive layer declines, and the accuracy of the thickness of the light transmissive layer decreases. Thus, the conventional molding mold assembly as shown in FIG. 11A is easy to cause the decrease in the accuracy of the thickness of the optical disc.

Further, as illustrated in FIG. 8B, on an olefin resin mold substrate 40B molded by the conventional molding mold assembly as shown in FIG. 12A, a burr B1 is comparatively large enough to have a height on the order of, e.g., 20 μm to 40 μm. Therefore, if a spacer layer 34B is formed to the thickness of 25 μm on the surface formed with the burr B1 of the olefin resin mold substrate 40B, the burr B1 might become equal to or larger than the thickness of the spacer layer 34B, so that the spacer layer 34B can not be formed uniformly to the thickness of 25 μm, resulting in the decline of the accuracy of the thickness of the whole optical disc.

The present embodiment illustrated in FIG. 7 is capable of obviating the inconvenience as shown in FIGS. 8A and 8B and is therefore effective particularly in improving the accuracy of the thickness of the optical disc including the 2-tiered information layer.

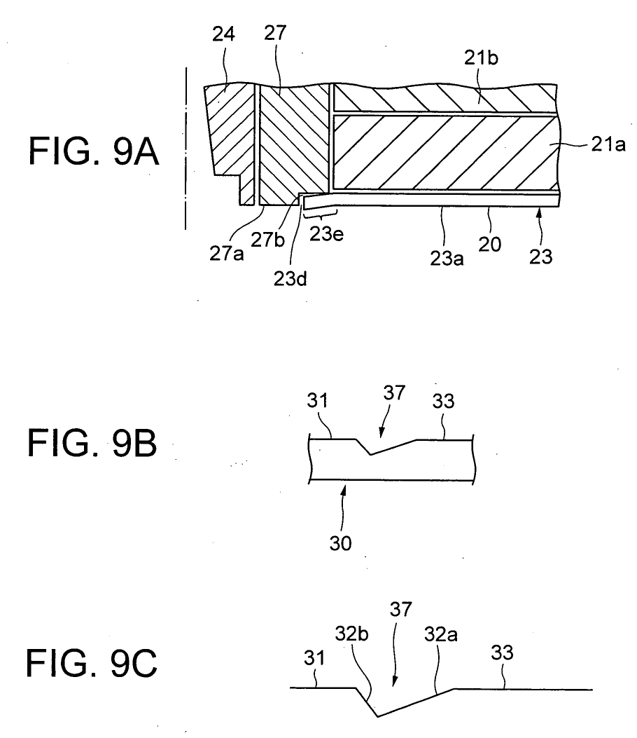

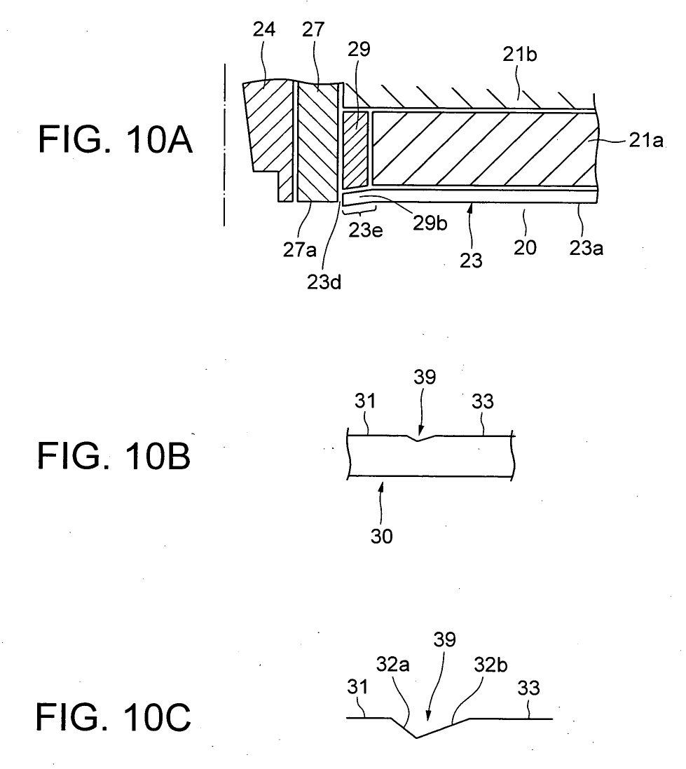

Next, a modified example in which the innermost periphery vicinal portion of the stamper in FIGS. 2A and 5A is formed protruding towards the cavity, will be described with reference to FIGS. 9A to 9C and 10A to 10C.

FIG. 9A shows a modified example of the molding mold assembly in FIG. 5A, and is an enlarged principal sectional view showing a one-sided principal portion of the fixed mold in the vicinity of the center in FIG. 1. FIG. 9B is a principal sectional view of a mold substrate molded by this molding mold assembly. FIG. 9C is an enlarged view of the surface of this mold substrate.

The following is the modified example illustrated in FIG. 9. As shown in FIG. 9A, a stepped portion is provided on an outer peripheral side of the end face 27a of the holder member 27, and a recessed portion 27b parallel with the end face 27a is formed. A flat face of the recessed portion 27b protrudes towards the cavity 20 from a fixed mirror surface portion 21a. The innermost periphery vicinal portion 23e of the stamper 23 is positioned at the recessed portion 27b of the holder member 27 and is thus slightly inclined as a tapered face, and its edge (the edge of the central hole 23d) protrudes towards the cavity 20 from the end face 27a of the holder member 27. The stamper face 23a apart from the innermost periphery vicinal portion 23e is a flat face that is substantially flush with (the same level as) the end face 27a of the holder member 27 (with respect to their positions in the vertical direction in FIG. 9A). Note that an amount of the protrusion of the innermost periphery vicinal portion 23e can be adjusted by changing an amount of recess of the recessed portion 27b.

The mold substrate 30 molded by the molding mold assembly shown in FIGS. 1 and 9A is, as shown in FIG. 9B, formed with the inner peripheral face 31 corresponding to the end face 27a of the holder member 27 and further formed with the information area face 33 onto which the hyperfine rugged pattern is transferred from the stamper face 23a, wherein the information area face 33 is substantially flush with the inner peripheral face 31. A recessed portion 37 recessed corresponding to the innermost periphery vicinal portion 23e is formed between the inner peripheral face 31 and the information area face 33. The recessed portion 37 is configured corresponding to the innermost periphery vicinal portion 23e and is therefore formed with, as shown in FIG. 9C, the inner periphery sided wall face 32b and the inclined state 32a as the intermediate configuration between the bottom face and the outer periphery sided wall face.

Further, the burr produced on the inner periphery sided wall face 32b of the recessed portion 37 corresponding to the portion between the holder member 27 and the stamper 23 is comparatively small as seen in FIG. 3A, wherein the height of the burr can be set less than, e.g., 20 μm. Note that the amount of the recess down to the bottom face of the recessed portion 37 from the information area face 33 or the inner peripheral face 31 be, it is preferable, within the range of 5 μm through 50 μm.

FIG. 10A shows another modified example of the molding mold assembly in FIG. 5A, and is an enlarged principal sectional view showing a one-sided principal portion of the fixed mold in the vicinity of the center in FIG. 1. FIG. 10B is a principal sectional view of a mold substrate molded by this molding mold assembly. FIG. 10C is an enlarged view of the surface of this mold substrate.

As shown in FIG. 10A, in the fixed mold 21 of the molding mold assembly in FIG. 1, the sleeve member 29 is disposed between the inner periphery sided lateral face of the fixed mirror surface portion 21a and an outer periphery sided lateral face of the holder member 27. In the fixed mold 21, the end face 29b of the sleeve member 29 is flat, then protrudes towards the cavity 20 from the fixed mirror surface portion 21a, and is positioned at the innermost periphery vicinal portion 23e on the side of the backface of the stamper 23. Then, the sleeve member 29 is disposed so that the end face 29b pushes the innermost periphery vicinal portion 23e from its backface.

The innermost periphery vicinal portion 23e of the stamper 23 is pushed by the end face 29a of the sleeve member 29 and is thereby slightly inclined, and its edge (the edge of the central hole 23d) protrudes from the end face 27a of the holder member 27 towards the cavity 20, thus forming a tapered face inclined therefrom. The stamper face 23a apart from the innermost periphery vicinal portion 23e is a flat face that is substantially flush with (the same level as) the end face 27a of the holder member 27 (with respect to their positions in the vertical direction in FIG. 10A).

Note that an amount of the protrusion of the innermost periphery vicinal portion 23e can be adjusted by changing a height position of the sleeve member 29.

The mold substrate 30 molded by the molding mold assembly shown in FIGS. 1 and 10A is, as shown in FIG. 10B, formed with the inner peripheral face 31 corresponding to the end face 27a of the holder member 27 and further formed with the information area face 33 onto which the hyperfine rugged pattern is transferred from the stamper face 23a, wherein the information area face 33 is substantially flush with the inner peripheral face 31. A recessed portion 39 recessed corresponding to the innermost periphery vicinal portion 23e is formed between the inner peripheral face 31 and the information area face 33. The recessed portion 39 is configured corresponding to the innermost periphery vicinal portion 23e and is therefore formed with, as shown in FIG. 10C, the inner periphery sided wall face 32b and the inclined state 32a as the intermediate configuration between the bottom face and the outer periphery sided wall face.

The mold substrate molded by the molding mold assembly having the construction in FIG. 9A or 10A is employed in the manufacturing process in FIGS. 6A to 6G, whereby the same effects as those in FIGS. 2A to 2C and FIGS. 54A to 5C can be obtained, the accuracy of the thickness of the spacer layer of the optical disc including the 2-tiered information layer can be improved, and the accuracy of the thickness of the whole optical disc including the 2-tiered information layer can be improved.

The present invention has been discussed so far by way of the embodiments but is not limited to these embodiments. The present invention can be modified in a variety of forms within the scope of the technical concept of the present invention. For example, in the manufacturing process in FIGS. 4A to 4C, the mold substrate 10 is molded by the molding mold assembly in FIG. 2A. The same effect can be, however, acquired when molded by the molding mold assembly in FIG. 9A or 10A.

Further, the Blu-ray disc has been exemplified with reference to FIGS. 4A to 4C, however, the present invention is not limited to the Blue-ray disc but can be applied to manufacturing a variety of optical discs such as the CD, the DVD, the optical disc capable of recording at a higher density than the DVD, and so on, wherein it is possible to improve the accuracy of the thickness of the optical disc by improving the coating property based on the spin coating.

Moreover, the optical disc including the 2-tiered information layer has been exemplified with reference to FIGS. 6A to 6G, however, the present invention is not limited to this optical disc, and a multi-tiered optical disc including a 3- or more-tiered information layer may also be available. Furthermore, in the case of the 2-tiered information layer (having the spacer layer), when the present invention is applied to the polycarbonate substrate as well as to the olefin resin substrate, more effects are acquired.

1. A molding mold comprising:
a mold member configuring a cavity for molding a mold substrate for an optical disc; and
a stamper for transferring a hyperfine pattern onto said mold substrate,
wherein said stamper is attached to said mold member so that a vicinal part of an innermost periphery portion of said stamper protrudes on the side of the cavity, and
a face formed by said mold member configuring an inner peripheral portion of said mold substrate is substantially flush with an information area face on which the hyperfine pattern has been transferred.

2. A molding mold comprising:
a mold member configuring a cavity for molding a resin stamper applied to a photo polymer method and used for transferring a hyperfine pattern onto a transferred face; and
a stamper for transferring the hyperfine pattern onto said resin stamper,
wherein said stamper is attached so that a vicinal part of an innermost periphery portion of said stamper protrudes on the side of the cavity, and
a face formed by said mold member configuring an inner peripheral portion of said resin stamper is substantially flush with an information area face on which the hyperfine pattern has been transferred.

3. A molding mold according to claim 1, wherein the vicinal part of the inner periphery portion of said stamper, which protrudes on the side of the cavity, is positioned within a range of 0.3 mm through 5 mm on the side of an outer periphery in a radial direction from the innermost periphery of said stamper.

4. A disc-shaped substrate for an optical disc, comprising:
an inner peripheral face so formed as to be configured by a mold member; and
an information area face including an information recording area in which a hyperfine pattern is transferred on the side of an outer periphery of said inner peripheral surface,
wherein said inner peripheral face is substantially flush with said information area face, and a recessed portion formed by the vicinal part of the inner peripheral portion of said stamper is configured between said inner peripheral face and said information area face.

5. A disc-shaped substrate for an optical disc according to claim 4, wherein said recessed portion configured between said information area face and said inner peripheral face is formed so that an inclined face extending towards said information area face has a more gentle slope than an inclined face extending towards said inner peripheral face from a deepest part of the recessed portion.

6. A disc-shaped substrate for an optical disc according to claim 5, wherein said recessed portion is positioned within a range of 0.3 mm through 5 mm on the outer peripheral side in the radial direction from a position where the recess starts from said inner peripheral face.

7. An optical disc comprising:
a substrate for an optical disc, including an inner peripheral face so formed as to be configured by a mold member, and an information area face having an information recording area in which a hyperfine pattern is formed on the side of an outer periphery of said inner peripheral surface, said inner peripheral face being substantially flush with said information area face, and a recessed portion formed by the vicinal part of the inner peripheral portion of said stamper being configured between said inner peripheral face and said information area face; and
a resin layer formed on said substrate for said optical disc.

8. An optical disc according to claim 7, wherein said resin layer is a light transmissive layer.

9. An optical disc according to claim 7, wherein said substrate for said optical disc is formed with said recessed portion configured between said information area face and said inner peripheral face so that an inclined face extending towards said information area face has a more gentle slope than an inclined face extending towards said inner peripheral face from a deepest part of the recessed portion.

10. An optical disc according to claim 7, wherein said recessed portion is positioned within a range of 0.3 mm through 5 mm on the outer peripheral side in the radial direction from a position where the recess starts from said inner peripheral face.

11. An optical disc comprising:
a substrate for an optical disc, including an inner peripheral face so formed as to be configured by a mold member, and an information area face having an information recording area in which a hyperfine pattern is formed on the side of an outer periphery of said inner peripheral surface, said inner peripheral face being substantially flush with said information area face, and a recessed portion formed by the vicinal part of the inner peripheral portion of said stamper being configured between said inner peripheral face and said information area face; and
a resin layer formed on said substrate for said optical disc and formed with a hyperfine pattern on its surface.

12. An optical disc according to claim 11, wherein said substrate for said optical disc is formed with said recessed portion configured between said information area face and said inner peripheral face so that an inclined face extending towards said information area face has a more gentle slope than an inclined face extending towards said inner peripheral face from a deepest part of the recessed portion.

13. An optical disc according to claim 11, wherein said recessed portion is positioned within a range of 0.3 mm through 5 mm on the outer peripheral side in the radial direction from a position where the recess starts from said inner peripheral face.

14. An optical disc according to claim 11, further comprising a light transmissive layer formed on the surface of said resin layer.

15. An optical disc comprising:
a substrate for said optical disc; and
a resin layer formed on said substrate for said optical disc,
wherein a face, opposite to said substrate, of said resin layer is formed corresponding to a resin stamper including an inner peripheral face so formed as to be configured by a mold member and an information area face having an information recording area in which a hyperfine pattern is formed on the side of an outer periphery of said inner peripheral surface,
said inner peripheral face is substantially flush with said information area face, and
a protruded portion is formed between said inner peripheral face and said information area face.

16. An optical disc according to claim 15, wherein said resin layer is formed with said protruded portion between said information area face and said inner peripheral face so that an inclined face extending towards said information area face has a more gentle slope than an inclined face extending towards said inner peripheral face from a highest part of the protruded portion.

17. An optical disc according to claim 15, wherein said protruded portion is positioned within a range of 0.3 mm through 5 mm on the outer peripheral side in the radial direction from a position where the protrusion starts from said inner peripheral face.

18. An optical disc according to claim 15, wherein a plurality of resin layers are provided.

19. An optical disc according to claim 15, further comprising a light transmissive layer formed at least on the surface of said resin layer.

20. An optical disc comprising:
a substrate for said optical disc including an inner peripheral face so formed as to be configured by a mold member, and an information area face having an information recording area in which a hyperfine pattern is formed on the side of an outer periphery of said inner peripheral surface, said inner peripheral face being substantially flush with said information area face, and a recessed portion formed by the vicinal part of the inner peripheral portion of said stamper being configured between said inner peripheral face and said information area face; and
a resin layer formed on said substrate for said optical disc;
wherein a face, opposite to said substrate, of said resin layer is formed corresponding to a resin stamper including an inner peripheral face so formed as to be configured by a mold member and an information area face having an information area in which a hyperfine pattern is formed on the side of an outer periphery of said inner peripheral surface,
said inner peripheral face is substantially flush with said information area face, and
a protruded portion is formed between said inner peripheral face and said information area face.

21. An optical disc according to claim 20, wherein said substrate for said optical disc is formed with said recessed portion configured between said information area face and said inner peripheral face so that an inclined face extending towards said information area face has a more gentle slope than an inclined face extending towards said inner peripheral face from a deepest part of the recessed portion.

22. An optical disc according to claim 20, wherein said recessed portion is positioned within a range of 0.3 mm through 5 mm on the outer peripheral side in the radial direction from a position where the recess starts from said inner peripheral face.

23. An optical disc according to claim 20, wherein said resin layer is formed with said protruded portion between said information area face and said inner peripheral face so that an inclined face extending towards said information area face has a more gentle slope than an inclined face extending towards said inner peripheral face from a highest part of the protruded portion.

24. An optical disc according to claim 20, wherein said protruded portion is positioned within a range of 0.3 mm through 5 mm on the outer peripheral side in the radial direction from a position where the protrusion starts from said inner peripheral face.

25. An optical disc according to claim 20, wherein a plurality of resin layers are provided.

26. An optical disc according to claim 20, further comprising a light transmissive layer formed on the surface of said resin layer.

27. A molding mold according to claim 2, wherein the vicinal part of the inner periphery portion of said stamper, which protrudes on the side of the cavity, is positioned within a range of 0.3 mm through 5 mm on the side of an outer periphery in a radial direction from the innermost periphery of said stamper.
